(19) United States
(12) Patent Application Publication
(10) Pub. No.: US 2018/0278069 A1
(43) Pub. Date: Sep. 27, 2018

(54) Charging Circuit And Mobile Terminal

(71) Applicant: Guangdong Oppo Mobile Telecommunications Corp., Ltd., Dongguan (CN)

(72) Inventor: Jialiang Zhang, Dongguan (CN)

(21) Appl. No.: 15/989,040

(22) Filed: May 24, 2018

Related U.S. Application Data
(63) Continuation of application No. 15/371,456, filed on Dec. 7, 2016.
Application No. 15/371,456 is a continuation of application No. PCT/CN2015/080499, filed on Jun. 1, 2015.

(51) Int. Cl. H02J 7/00

(52) U.S. Cl. CPC H02J 7/0044; H02J 2007/0059; H02J 7/00; H02J 7/0052

(57) ABSTRACT

A charging circuit and a mobile terminal are provided. The charging circuit is coupled between a charging interface and a battery of a mobile terminal. The charging circuit includes a first circuit, a capacitive coupling element, and a second circuit connected in series between the charging interface and the battery. The capacitive coupling element is configured to disconnect a direct current (DC) path of the charging circuit. The capacitive coupling element includes at least one capacitor and the capacitor of the capacitive coupling element is one of the following capacitors: a capacitor composed of a printed circuit board (PCB) and a capacitor composed of a flexible printed circuit (FPC) board. A size, shape, or thickness of the capacitor of the capacitive coupling element is designed based on a structure of the mobile terminal.

### CROSS-REFERENCE TO RELATED APPLICATION

This application is a continuation of U.S. Ser. No. 15/371,456, filed on Dec. 7, 2016, which is a continuation of International Application No. PCT/CN2015/080499, filed on Jun. 1, 2015, the contents of both of which are herein incorporated by reference in their entireties.

### TECHNICAL FIELD

The present disclosure relates to mobile terminal field, and particularly to a charging circuit and a mobile terminal.

### BACKGROUND

With the growing popularity of mobile terminal use, terminal charging has become a focused issue of mobile terminal providers.

### SUMMARY

Disclosed herein are implementations of a charging circuit, coupled between a charging interface and a battery of a mobile terminal, the charging circuit including a first circuit, a capacitive coupling element, and a second circuit connected in series between the charging interface and the battery, the capacitive coupling element being configured to disconnect a direct current (DC) path of the charging circuit, the capacitive coupling element including at least one capacitor and the capacitor of the capacitive coupling element is one of the following capacitors: a capacitor composed of a printed circuit board (PCB) and a capacitor composed of a flexible printed circuit (FPC) board, and a size, shape, or thickness of the capacitor of the capacitive coupling element being designed based on a structure of the mobile terminal, where the first circuit includes a bridge-arm circuit and a control circuit controlling the bridge-arm circuit, the bridge-arm circuit is provided with a switch transistor with a lower on-resistance to reduce heating and loss and improve energy transfer efficiency of the whole charging circuit, and the bridge-arm circuit is configured to be connected with the charging interface and perform at least one of charging and discharging on the capacitor of the capacitive coupling element under control of the control circuit to convert a DC to an alternating current (AC), where the DC is output from the charging interface and is used for charging, and the second circuit is configured to adjust the AC to a DC suitable for charging the battery, where the AC is coupled to the second circuit by the first circuit through the capacitive coupling element.

Disclosed herein are also implementations of a mobile terminal, including a charging interface, a battery, and an charging circuit coupled between the charging interface and the battery of the mobile terminal, the charging circuit including a first circuit, a capacitive coupling element, and a second circuit connected in series between the charging interface and the battery, the capacitive coupling element being configured to disconnect a direct current (DC) path of the charging circuit, the capacitive coupling element including at least one capacitor and the capacitor of the capacitive coupling element is one of the following capacitors: a capacitor composed of a printed circuit board (PCB) and a capacitor composed of a flexible printed circuit (FPC) board, and a size, shape, or thickness of the capacitor of the capacitive coupling element being designed based on a structure of the mobile terminal, where the first circuit includes a bridge-arm circuit and a control circuit controlling the bridge-arm circuit, the bridge-arm circuit is provided with a switch transistor with a lower on-resistance to reduce heating and loss and improve energy transfer efficiency of the whole charging circuit, and the bridge-arm circuit is configured to be connected with the charging interface and perform at least one of charging and discharging on the capacitor of the capacitive coupling element under control of the control circuit to convert a DC to an alternating current (AC), where the DC is output from the charging interface and is used for charging; and the second circuit is configured to adjust the AC to a DC suitable for charging the battery, where the AC is coupled to the second circuit by the first circuit through the capacitive coupling element.

Disclosed herein are also implementations of a charging circuit, including a first circuit, a capacitive coupling element, and a second circuit connected in series, where the first circuit includes a bridge-arm circuit and a control circuit controlling the bridge-arm circuit, the bridge-arm circuit is configured to be connected with a charging interface of a terminal, and the second circuit is configured to be connected with a battery of the terminal.

### BRIEF DESCRIPTION OF THE DRAWINGS

In order to illustrate the technical solutions of the present disclosure or the related art more clearly, a brief description of the accompanying drawings used herein is given below. Obviously, the drawings listed below are only examples, and a person skilled in the art should be noted that, other drawings can also be obtained on the basis of these exemplary drawings without creative work.

FIG. 1 is a circuit diagram illustrating a charging circuit.

FIG. 2 is a block schematic diagram illustrating a charging circuit according to an implementation of the present disclosure.

FIG. 3 is a circuit diagram illustrating a charging circuit according to an implementation of the present disclosure.

FIG. 4 is a circuit diagram illustrating a charging circuit according to an implementation of the present disclosure.

FIG. 5 is a block schematic diagram illustrating a mobile terminal according to an implementation of the present disclosure.

### DETAILED DESCRIPTION

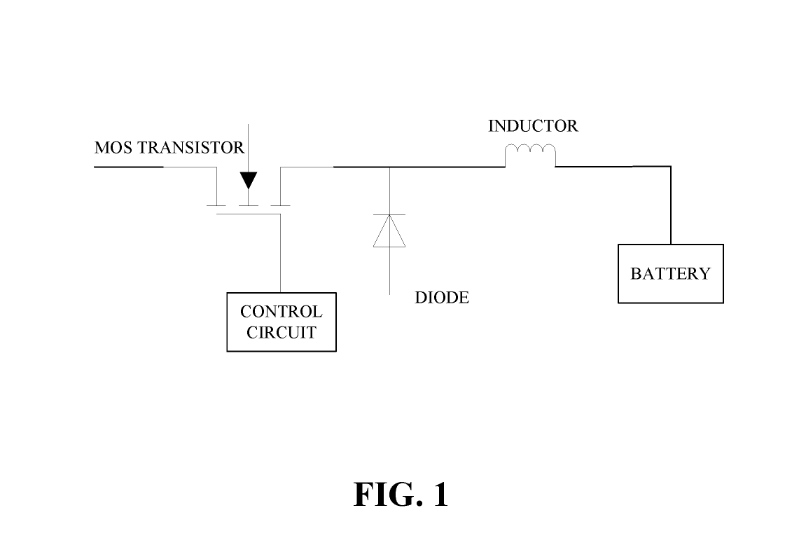

FIG. 1 is a circuit diagram illustrating a charging circuit used in a mobile terminal. This charging circuit is known as BUCK circuit, which includes a MOS transistor, a control circuit, a diode, an inductor, and a battery. Upon charging, the control circuit controls the MOS transistor to turn-on/turn-off to generate a changing square wave current. The square wave current flows to the inductor from the MOS transistor, and then flows to the battery after voltage stabilization conducted by the inductor.

The above-mentioned charging process can have a risk of MOS transistor breakdown. Upon MOS transistor breakdown, the current will flow through the inductor, a current/voltage detecting circuit, and the battery directly; this can cause the battery to exceed a limit voltage and may even lead to more serious consequences.

The cause of the damage to the MOS transistor can be as follows.

The MOS transistor is mis-energized; the voltage at both ends of the MOS transistor exceeds a maximum voltage that can be withstood; electrostatic breakdown or surge.

The MOS transistor is of poor quality; or, there is an integrated manufacture technology issue.

There can be other defects.

In order to avoid the above problems and improve the reliability of the MOS transistor, the value of on-resistance (RDSON) of the MOS transistor has been increased so as to improve the voltage resistance of the MOS transistor. On the other hand, high resistance, in turn, would cause the charging circuit to be easy to heat, low energy transmission efficiency and so on.

Technical solutions of the implementations of the present disclosure will be described clearly and completely taken in conjunction with the accompanying drawings; it will be apparent to one of ordinary skill in the art that, the implementations described below are merely a part of the disclosure and other implementations obtained out of them without creative work will fall into the protection range of the present disclosure either.

Implementation 1

According to implementation 1 of the present disclosure, it is provided a charging circuit. In the following, the components of the charging circuit will be described in detail. A person skilled in the art will be able to arrange or assemble the charging circuit in accordance teaching of the description by using routine methods of experimentation or analysis without undue efforts. Any method used to assemble the charging circuit of the present disclosure will fall into the protection scope defined by the appending claims.

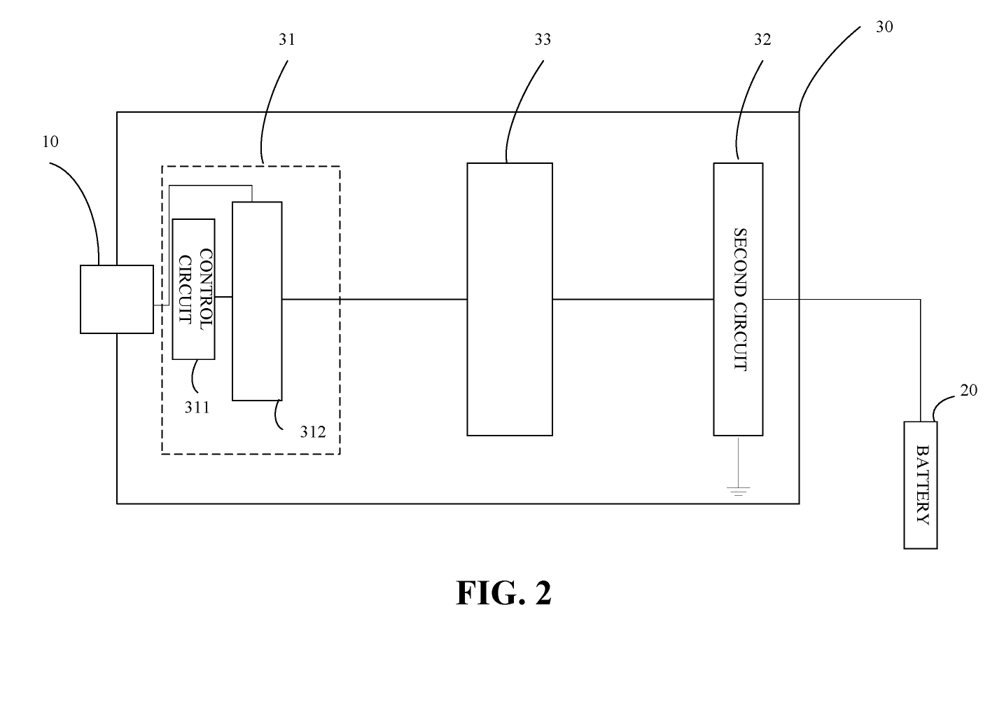

FIG. 2 is block schematic diagram illustrating the charging circuit according to an implementation of the present disclosure. As shown in FIG. 2, a charging circuit 30 is arranged between a charging interface 10 and a battery 20 of a terminal. The charging circuit 30 includes a first circuit 31, a capacitive coupling element 33, and a second circuit 32 connected in series successively between the charging interface 10 and the battery 20. The capacitive coupling element 33 disconnects a direct-current (DC) path of the charging circuit 30.

In at least one implementation, the first circuit 31 includes a bridge-arm circuit 312 and a control circuit 311 controlling the bridge-arm circuit. The bridge-arm circuit 312 connects with the charging interface 10, and is configured to charge/discharge capacitors in the capacitive coupling element 33 under control of the control circuit 311 so as to convert DC, which is output from the charging interface 10 and is used for charging, to AC.

The second circuit 32 is configured to adjust alternating current (AC), which is coupled to the second circuit 32 by the first circuit 31 through the capacitive coupling element 33, to DC which is suitable for charging the battery.

In this technical scheme, a DC path of the charging circuit is separated by the capacitive coupling element. That is to say, there is no DC path in the charging circuit. DC current from the charging interface would not be output directly to the second circuit and the battery upon failure of the first circuit, whereby reliability of the charging circuit is improved.

### Example 1

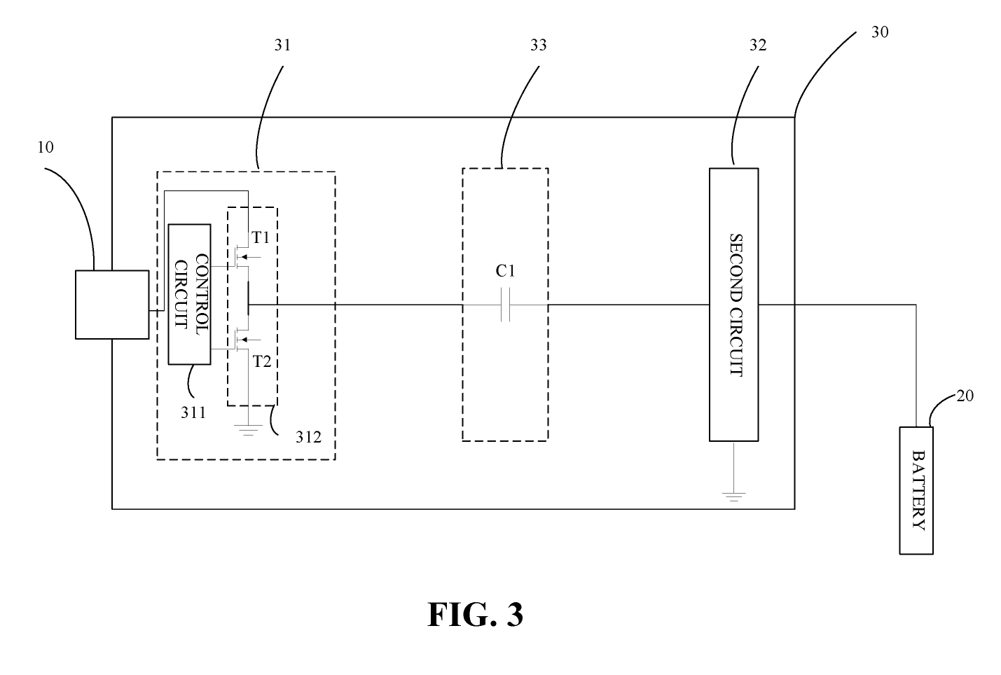

FIG. 3 is a circuit diagram illustrating a charging circuit according to Example 1. As shown in FIG. 3, the capacitive coupling element 33 includes a capacitor C1, and the bridge-arm circuit 312 is a half-bridge circuit including a first switch transistor T1 and a second switch transistor T2. With the aid of the half-bridge circuit, efficiency of the whole circuit can be improved.

In at least one implementation, a first end of the first switch transistor T1 connects with the charging interface 10, a second end of the first switch transistor T1 connects with a first end of the capacitor C1, and a control end of the first switch transistor T1 connects with the control circuit 311. A first end of the second switch transistor T2 connects with the second end of the first switch transistor T1, a second end of the second switch transistor T2 connects to ground, and a control end of the second switch transistor T2 connects to the control circuit 311. A second end of the capacitor C1 connects to ground via the second circuit 32. The battery 20 connects to ground.

Typically, a switch transistor (such as a MOS transistor), which is easy breakdown, is arranged within the first circuit. When breakdown of the switch transistor occurs, the first circuit could not convert DC to AC via the switch transistor; this cause DC input at the charging interface being applied to a subsequent component of the charging interface or a battery directly. However, in this example, with the aid of the capacitive coupling element arranged between the first circuit and the second circuit, a DC path of the charging circuit can be disconnected; therefore, AC is conducted while DC is blocked. That is to say, DC input at the charging interface cannot flow to the second circuit or the battery even if the switch transistor in the first circuit is broke down or failure, whereby the reliability of the charging circuit of the mobile terminal can be improved.

In addition, the capacitive coupling element has good isolation performance. Thus, instead of increasing the on-resistance so as to increase the voltage resistance of the MOS transistor and then improve the reliability of the circuit like in the prior art, in implementations of the present disclosure, a lower on-resistance of the switch transistor in the first circuit is allowed, and this will improve the energy transfer efficiency of the whole charging circuit while reducing heating and loss.

### Example 2

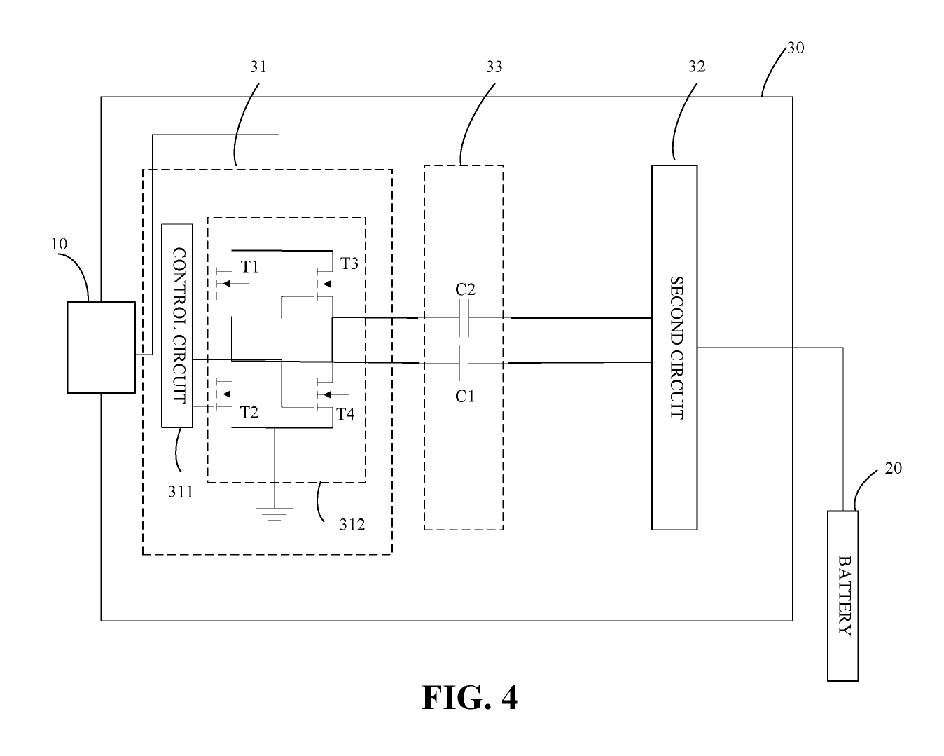

FIG. 4 is a circuit diagram illustrating a charging circuit according to Example 2. As shown in FIG. 4, the capacitive coupling element 33 includes a first capacitor C1 and a second capacitor C2, and the bridge-arm circuit 312 is a full-bridge circuit including a first switch transistor T1, a second switch transistor T2, a third switch transistor T3, and a fourth switch transistor T4. A difference between example 1 and example 2 is that, in example 2, the full-bridge circuit is used to replace the half-bridge circuit in example 1. With the aid of the full-bridge circuit, efficiency of the whole circuit can be further improved.

In at least one implementation, a first end of the first switch transistor T1 connects with the charging interface 10, a second end of the first switch transistor T1 connects with a first end of the first capacitor C1, and a control end of the first switch transistor T1 connects with the control circuit 311. A first end of the second switch transistor T2 connects with the second end of the first switch transistor T1, a second end of the second switch transistor T2 connects to ground, and a control end of the second switch transistor T2 connects with the control circuit 311. A first end of the third switch transistor T3 connects with the charging interface 10, a second end of the third switch transistor T3 connects with the first end of the second capacitor C2, and a control end of the third switch transistor T3 connects with the control circuit 311. A first end of the fourth switch transistor T4 connects with the second end of the third switch transistor T3, a second end of the fourth switch transistor T4 connects to ground, and a control end of the fourth switch transistor T4 connects with the control circuit 311. A second end of the first capacitor C1 connects with the second circuit 32; a second end of the second capacitor C2 connects with the second circuit 32.

Typically, a switch transistor (such as a MOS transistor), which is easy breakdown, is arranged within the first circuit. When breakdown of the switch transistor occurs, the first circuit could not convert DC to AC via the switch transistor; this cause DC input at the charging interface being applied to a subsequent component of the charging interface or a battery directly. However, in this example, with the aid of the capacitive coupling element arranged between the first circuit and the second circuit, a DC path of the charging circuit can be disconnected; therefore, AC is conducted while DC is blocked. That is to say, DC input at the charging interface cannot flow to the second circuit or the battery even if the switch transistor in the first circuit is broke down or failure, whereby the reliability of the charging circuit of the mobile terminal can be improved.

In addition, the capacitive coupling element has good isolation performance. Thus, instead of increasing the on-resistance so as to increase the voltage resistance of the MOS transistor and then improve the reliability of the circuit like in the prior art, in implementations of the present disclosure, a lower on-resistance of the switch transistor in the first circuit is allowed, and this will improve the energy transfer efficiency of the whole charging circuit while reducing heating and loss.

Optionally, the capacitor of the capacitive coupling element 33 can be one of the following capacitors: a capacitor composed of a printed circuit board (PCB); a capacitor composed of a flexible printed circuit (FPC) board.

In at least one implementation, the capacitor composed of PCB can be a capacitor composed of PCB sheets and copper foil on the sheets. The capacitor composed of FPC board can be a capacitor composed and designed by FPC. One of the advantages of the capacitor composed of PCB and the capacitor composed of FPC board lies in that, the size, shape, or thickness of the capacitor of the capacitive coupling element is designed based on the structure of the mobile terminal; in other words, the capacitor can be designed arbitrarily to have any shape, any size, or any thickness according to the structure and shape of the mobile terminal such as a smart phone.

In at least one implementation, the bridge-arm circuit includes a plurality of metal oxide semiconductor field effect transistors (MOSFET).

In at least one implementation, the second circuit includes a rectifier circuit and a filter circuit.

Implementation 2

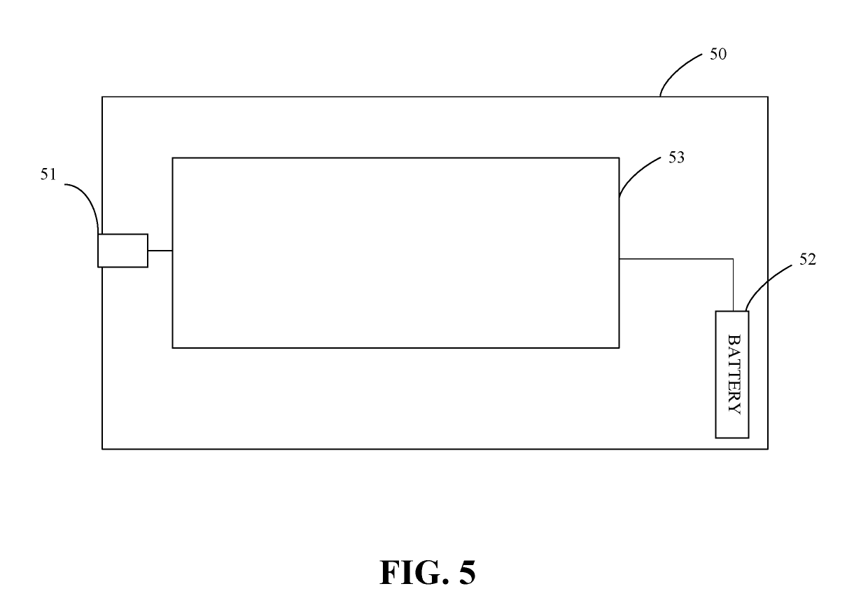

According to Implementation 2 of the present disclosure, it is provided a mobile terminal. FIG. 5 is a block schematic diagram illustrating the mobile terminal. As shown in FIG. 5, a mobile terminal 50 includes a charging interface 51, a battery 52, and a charging circuit 53 arranged between the charging interface 51 and the battery 52. The charging circuit 53 can adopt any of the implementations of the charging circuit 30 described above.

For details of the charging circuit 53, please refer to the charging circuit 30 described above with refer to FIG. 2-FIG. 4, and it will not be described here again in order to avoid redundancy.

In the technical scheme described above, a DC path of the charging circuit is separated by the capacitive coupling element. That is to say, there is no DC path in the charging circuit. DC current from the charging interface would not be output directly to the second circuit and the battery upon failure of the first circuit, whereby reliability of the charging circuit is improved.

As an implementation, the charging interface 51 is a USB interface or any other interface corresponds to related industry standards of terminal charging interface.

As an implementation, the mobile terminal 50 is operable in (in other words, supports) a normal charging mode and a quick charging mode, wherein charging current is larger in the quick charging mode than in the normal charging mode.

It should be understood that the phenomenon of MOS transistor breakdown is particularly serious in the mobile terminal which supports quick charging. As to the problem of circuit unreliability upon quick charging caused by MOS transistor breakdown, the mobile terminal according to the implementation of the present disclosure can be a good solution.

A person skilled in the art will understand, exemplary units or algorithm steps described in any of the implementations can be achieved via electronic hardware or a combination of electronic hardware and computer software. Whether hardware or software should be adopted depends on design constraints and specific applications of the technical schemes. Respective specific application can use different methods or manners to achieve the function described in the implementations, which will fall into the protection scope of the present disclosure.

Specific operations of the device, system, and the unit or module can cross-refer to corresponding descriptions according to the implementation, and will not go into much detail here.

In the implementations of the present disclosure, the device and system described herein can be achieved in other manners. The configuration of the device according to the implementation described above is only exemplary; the division of units in the device is a kind of division according to logical function, therefore there can be other divisions in practice. For example, multiple units or components can be combined or integrated into another system; or, some features can be ignored while some units need not to be executed. On the other hand, various function units can be integrated into one processing unit; two or more than two units can be integrated into one unit; or, each unit is physically separate.

Furthermore, various function units can be integrated into one processing unit; two or more than two units can be integrated into one unit; or, each unit is physically separate.

Operations or functions of technical schemes according to the implementations of the present disclosure, when achieved in the form of software functional units and sold or used as an independent product, can be stored in a computer readable storage medium. According to this, all or a part of the technical schemes of the present disclosure can be realized in the form of software products which can be stored in a storage medium. The storage medium includes USB disk, Read Only Memory (ROM), Random Access Memory (RAM), magnetic disk, CD, and any other medium that can be configured to store computer-readable program code or instructions. The computer-readable program code, when executed on a data-processing apparatus (can be personal computer, server, or network equipment), adapted to perform all or a part of the methods described in the above-mentioned implementations.

The foregoing descriptions are merely preferred implementations of the present disclosure, rather than limiting the present disclosure. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A charging circuit, coupled between a charging interface and a battery of a mobile terminal, the charging circuit comprising a first circuit, a capacitive coupling element, and a second circuit connected in series between the charging interface and the battery, the capacitive coupling element being configured to disconnect a direct current (DC) path of the charging circuit, the capacitive coupling element comprising at least one capacitor and the capacitor of the capacitive coupling element is one of the following capacitors: a capacitor composed of a printed circuit board (PCB) and a capacitor composed of a flexible printed circuit (FPC) board, and a size, shape, or thickness of the capacitor of the capacitive coupling element being designed based on a structure of the mobile terminal, wherein
the first circuit comprises a bridge-arm circuit and a control circuit controlling the bridge-arm circuit, the bridge-arm circuit is provided with a switch transistor with a lower on-resistance to reduce heating and loss and improve energy transfer efficiency of the whole charging circuit, and the bridge-arm circuit is configured to be connected with the charging interface and perform at least one of charging and discharging on the capacitor of the capacitive coupling element under control of the control circuit to convert a DC to an alternating current (AC), wherein the DC is output from the charging interface and is used for charging; and
the second circuit is configured to adjust the AC to a DC suitable for charging the battery, wherein the AC is coupled to the second circuit by the first circuit through the capacitive coupling element.

2. The charging circuit of claim 1, wherein the capacitive coupling element comprises one capacitor, and the bridge-arm circuit is a half-bridge circuit comprising a first switch transistor and a second switch transistor, wherein
the first switch transistor has a first end configured to be connected with the charging interface, a second end connected with a first end of the capacitor, and a control end connected with the control circuit;
the second switch transistor has a first end connected with the second end of the first switch transistor, a second end configured to be grounded, and a control end connected with the control circuit; and
the capacitor has a second end configured to be grounded via the second circuit and the battery.

3. The charging circuit of claim 1, wherein the capacitive coupling element comprises a first capacitor and a second capacitor, and the bridge-arm circuit is a full-bridge circuit comprising a first switch transistor, a second switch transistor, a third switch transistor, and a fourth switch transistor, wherein
the first switch transistor has a first end configured to be connected with the charging interface, a second end connected with a first end of the first capacitor, and a control end connected with the control circuit;
the second switch transistor has a first end connected with the second end of the first switch transistor, a second end configured to be grounded, and a control end connected with the control circuit;
the third switch transistor has a first end configured to be connected with the charging interface, a second end connected with a first end of the second capacitor, and a control end connected with the control circuit;
the fourth switch transistor has a first end connected with the second end of the third switch transistor, a second end configured to be grounded, and a control end connected with the control circuit;
the first capacitor has a second end connected with the second circuit; and
the second capacitor has a second end connected with the second circuit.

4. The charging circuit of claim 1, wherein the bridge-arm circuit comprises a plurality of metal oxide semiconductor field effect transistors (MOSFET).

5. The charging circuit of claim 2, wherein the bridge-arm circuit comprises a plurality of metal oxide semiconductor field effect transistors (MOSFET).

6. The charging circuit of claim 3, wherein the bridge-arm circuit comprises a plurality of metal oxide semiconductor field effect transistors (MOSFET).

7. The charging circuit of claim 1, wherein the second circuit comprises a rectifier circuit and a filter circuit.

8. The charging circuit of claim 2, wherein the second circuit comprises a rectifier circuit and a filter circuit.

9. The charging circuit of claim 3, wherein the second circuit comprises a rectifier circuit and a filter circuit.

10. A mobile terminal, comprising a charging interface, a battery, and an charging circuit coupled between the charging interface and the battery of the mobile terminal, the charging circuit comprising a first circuit, a capacitive coupling element, and a second circuit connected in series between the charging interface and the battery, the capacitive coupling element being configured to disconnect a direct current (DC) path of the charging circuit, the capacitive coupling element comprising at least one capacitor and the capacitor of the capacitive coupling element is one of the following capacitors: a capacitor composed of a printed circuit board (PCB) and a capacitor composed of a flexible printed circuit (FPC) board, and a size, shape, or thickness of the capacitor of the capacitive coupling element being designed based on a structure of the mobile terminal, wherein
the first circuit comprises a bridge-arm circuit and a control circuit controlling the bridge-arm circuit, the bridge-arm circuit is provided with a switch transistor with a lower on-resistance to reduce heating and loss and improve energy transfer efficiency of the whole charging circuit, and the bridge-arm circuit is configured to be connected with the charging interface and perform at least one of charging and discharging on the capacitor of the capacitive coupling element under control of the control circuit to convert a DC to an alternating current (AC), wherein the DC is output from the charging interface and is used for charging; and
the second circuit is configured to adjust the AC to a DC suitable for charging the battery, wherein the AC is coupled to the second circuit by the first circuit through the capacitive coupling element.

11. The mobile terminal of claim 10, wherein the charging interface is a universal serial bus (USB) interface.

12. The mobile terminal of claim 10, wherein the mobile terminal is operable in a normal charging mode and a quick charging mode, and a charging current is larger in the quick charging mode than in the normal charging mode.

13. The mobile terminal of claim 10, wherein the capacitive coupling element comprises one capacitor, and the bridge-arm circuit is a half-bridge circuit comprising a first switch transistor and a second switch transistor, wherein
the first switch transistor has a first end configured to be connected with the charging interface, a second end connected with a first end of the capacitor, and a control end connected with the control circuit;
the second switch transistor has a first end connected with the second end of the first switch transistor, a second end configured to be grounded, and a control end connected with the control circuit; and
the capacitor has a second end configured to be grounded via the second circuit and the battery.

14. The mobile terminal of claim 10, wherein the capacitive coupling element comprises a first capacitor and a second capacitor, and the bridge-arm circuit is a full-bridge circuit comprising a first switch transistor, a second switch transistor, a third switch transistor, and a fourth switch transistor, wherein
the first switch transistor has a first end configured to be connected with the charging interface, a second end connected with a first end of the first capacitor, and a control end connected with the control circuit;
the second switch transistor has a first end connected with the second end of the first switch transistor, a second end configured to be grounded, and a control end connected with the control circuit;
the third switch transistor has a first end configured to be connected with the charging interface, a second end connected with a first end of the second capacitor, and a control end connected with the control circuit;
the fourth switch transistor has a first end connected with the second end of the third switch transistor, a second end configured to be grounded, and a control end connected with the control circuit;
the first capacitor has a second end connected with the second circuit; and
the second capacitor has a second end connected with the second circuit.

15. The mobile terminal of claim 10, wherein the bridge-arm circuit comprises a plurality of metal oxide semiconductor field effect transistors (MOSFET).

16. The mobile terminal of claim 10, wherein the second circuit comprises a rectifier circuit and a filter circuit.
